(19) United States
(12) Patent Application Publication
(10) Pub. No.: US 2007/0117595 A1
(43) Pub. Date: May 24, 2007

(54) Devices, methods and computer program products for providing a preferred operational mode to a wireless terminal

(76) Inventor: Stephen Sherman, Alpharetta, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/284,996

(22) Filed: Nov. 22, 2005

(51) Int. Cl. H04M 3/00; H04Q 7/20

(52) U.S. Cl. 455/567; 455/565; 455/456.4; 455/420

(57) ABSTRACT

A device for proximity detection of a wireless terminal includes: a transmitter for transmitting signals inside an area; and a processor operable for instructing the transmitter to transmit a control signal notifying the wireless terminal of a preferred operational mode of the wireless terminal for the area.

### BACKGROUND

Mobile or wireless terminals, such as cell phones, mobile phones, and similar wireless devices are no longer the hallmark of traveling business executives and other professionals, but have become essential personal items that are always carried by many people all over the world on their persons.

Modern cell phones are equipped with a feature know as enhanced home network. This feature allows cell phone users to operate their phone throughout North America or the European Community commonly without incurring roaming charges. Because the cell phones are, therefore, operational at no additional prohibitive cost across borders between states or countries, there is no reason to leave them behind while traveling. In a sense, the cell phone goes where its owner goes, and this, unfortunately, includes environments in which the use of a cell phone is undesirable, dangerous, or even illegal.

In entertainment places, such a theaters, opera houses, symphony and music halls, ringing of cell phones is not only disruptive, but it may also interfere with aesthetic or other aspects of the performance. In government buildings and courthouses, security reasons may place additional restrictions on the use or even admittance of cell phones. In airplanes, explosives handling sites, hospitals, and other places in which radio-operated equipment may be used, the operation of cell phones may lead to spurious radio transmissions that may cause interference, malfunction, and may even trigger catastrophic events.

Currently, X-Ray machines and scanners are used to discover and confiscate cell phones at the entrance to courthouses and other places in which these devices are prohibited. Spotting miniature cell phones through X-Ray machines is not only difficult but it is also time consuming.

Another solution being used is a jamming device for mobile phone signals that disrupts the reception of the signal at the mobile phone, making it impossible to receive service from the mobile network. A permit is usually required in order to operate this device and it is currently illegal to use such a device in the United States. When this device is used, functions such as Short Messaging Service (SMS), email, and Internet access are all disabled.

### SUMMARY

Exemplary embodiments include a device for proximity detection of a wireless terminal including: a transmitter for transmitting a control signal inside an area; and a processor operable for instructing the transmitter to notify the wireless terminal of a preferred operational mode for the area.

Exemplary embodiments also include a method for proximity detection of a wireless terminal including: determining a preferred operational mode of the wireless terminal inside an area; and transmitting a control signal indicating the preferred operational mode for the area to the wireless terminal.

Exemplary embodiments further include a computer program product for proximity detection of a wireless terminal, the computer program product including: a storage medium readable by a processing circuit and storing instructions for execution by the processing circuit for facilitating a method including: determining a preferred operational mode of the wireless terminal inside an area; and transmitting a control signal indicating the preferred operational mode for the area to the wireless terminal.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several Figures:

FIG. 1 is a block diagram of a detection device in exemplary embodiments;

FIG. 2 is a diagrammatic view of a detection device in an operation environment in exemplary embodiments; and

FIG. 3 is a flowchart of the operation of the detection device in exemplary embodiments.

### DETAILED DESCRIPTION

Referring now to the Figures for the purpose of illustrating the invention and not for the purpose of limiting the same, it is to be understood that standard components or features that are within the purview of an artisan of ordinary skill and do not contribute to the understanding of the various embodiments of the invention are omitted from the Figures to enhance clarity.

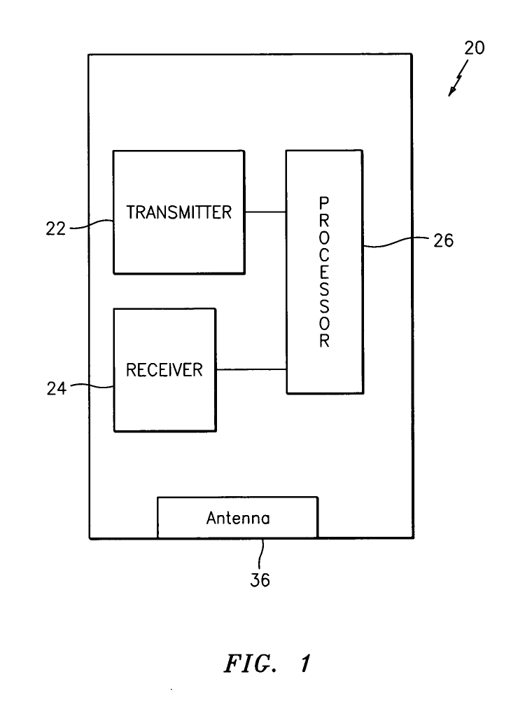

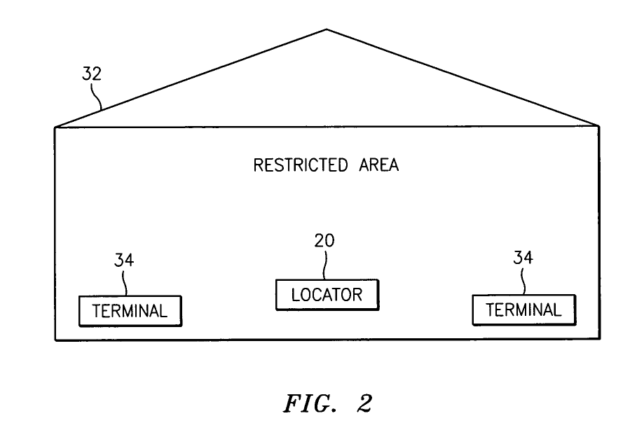

FIG. 1 is a block diagram of the detection device 20 in exemplary embodiments for use in a restricted area 32, shown in FIG. 2. Exemplary embodiments of the detection device 20 include a transmitter 22 and a receiver 24. While shown as distinct elements, it should be appreciated that the transmitter and the received may be incorporated into a single transceiver. The detection device 20 may also include a processor 26, the processor 26 including a data storage device, a microprocessor, and a logic controller. The processor 26 may be in operable communication with a display and an input device. The input device may include, but is not limited to, a keyboard, a switch, or a knob. The detection device 20 may also include an antenna 36 for transmitting a control signal to the wireless terminals 34 (shown in FIG. 2). The antenna 36 is in operable communication with the transmitter 22 and the receiver 24 and is utilized to facilitate communication between both the transmitter 22 and the receiver 24 and the wireless terminals 34. The antenna 36 may be any suitable antenna type including, but not limited to, dipole, monopole, patch, bicone, monocone, notch, horn, or reflector antenna.

In exemplary embodiments, the detection device 20, labeled as a locator in FIG. 2, may be portable or may be mounted on a wall or surface. The detection device 20 may be used with any wireless terminal 34 including, but not limited to, cell phones, pagers, wristwatch phones, and PDA devices that can communicate wirelessly by means of electromagnetic radiation regardless of the service carrier. Both analog and digital wireless terminals 34 may be utilized without modification and regardless of the underlying network protocols. The underlying network protocols may include, but is not limited to, AMPS, NAMPS, TDMA, CDMA, GSM-NA, PACS, etc. Wireless terminals 34 may also include email and pager devices that operate through the various underlying network protocols. In exemplary embodiments, the receiver 24 is capable of receiving an overhead signal from the wireless terminal 34. The overhead signal includes the wireless communication signal between the wireless terminal 34 and a wireless service provider.

Turning now to FIG. 2, a diagrammatic view of exemplary embodiments of the detection device 20 in an operation environment is shown. The detection device 20 may be programmed to transmit a control signal to wireless terminals 34 within a restricted area 32. According to an exemplary embodiment, the control signal includes a preferred operational mode for the wireless terminal 34 inside of the restricted area 32. The restricted area 32 is defined as an area in which the unrestricted use of the wireless terminals 34 is undesirable or prohibited. In exemplary embodiments, the restricted area 32 may be a stationary structure or facility including but not limited to, a government building, a courthouse, a hospital, a restaurant, or a theater. In other exemplary embodiments, the restricted area 32 may be a mobile facility such as an airplane or a boat.

The preferred operational mode may include an availability of a feature of the wireless terminal 34 and a setting of the wireless terminal 34. The features of the wireless terminal 34 may include, but are not limited to, a voice call, a SMS, an email, a camera functionality, a video functionality, and a pager. Additionally, the settings of the wireless terminal 34 may include, but are not limited to, a ring volume, a ring tone, an alert volume, an alert tone, a flash, and a backlight intensity. After receiving the control signal with the preferred operational mode, the wireless terminal 34 presents the user with an option to accept the preferred operational mode while in the restricted area 32. In exemplary embodiments, the processor 26 may store a previous operational mode of the wireless terminal 34 when the user elects to adopt the preferred operational mode. Additionally, the processor 26 may revert the wireless terminal 34 to the previous operational mode when the control signal is no longer detected.

In exemplary embodiments the detection device 20 can use the processor 26 to store information about wireless terminals 34, including the preferred operating mode of the wireless terminal 34 in the restricted area 32. For example, if the restricted area 32 is a church, movie theater, or some other place that an individual visits on a regular basis, the processor 26 may keep track of the preferred operational mode of the user's wireless terminal 34. In exemplary embodiments, the user may be prompted to have the detection device 20 store the preferred operation mode of their wireless device 34 and automatically switch the operational mode of the wireless terminal 34 when it is present in the restricted area.

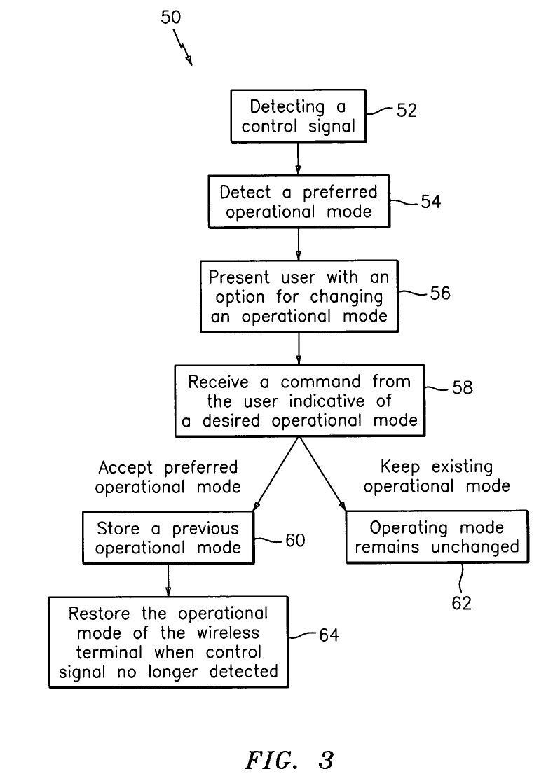

Turning now to FIG. 3 a flowchart of the operation of exemplary embodiments of the detection device 20 is illustrated generally as 50. As shown in process block 52, when inside of the restricted area 32 the wireless terminal 34 detects a control signal emitted by the detection device 20. After detecting the control signal, the wireless terminal 34 receives the preferred operational mode for the wireless terminal 34, as depicted in process block 54. Upon receiving the preferred operation mode for the wireless terminal 34, the wireless terminal 34 presents the user with an option for changing the operational mode of the wireless terminal 34 to the preferred operational mode, as shown in process block 56.

Continuing with FIG. 3, as depicted at process block 58 the wireless terminal 34 receives a command from the user indicative of a desired operational mode of the wireless terminal 34. If the user indicates that the operational mode of the wireless terminal 34 should be changed to the preferred operational mode the process proceeds to process block 60. Otherwise, the operational mode of the wireless terminal 34 remains unchanged, as shown at process block 62. If the user adapts the preferred operational mode for the wireless terminal 34, the wireless terminal may store a previous operational mode of the wireless device, as shown at process block 60. Additionally, the wireless terminal 34 may restore the operational mode of the wireless terminal to the previous operational mode when the control signal is no longer detected, as shown at process block 64. The restoration of the previous operational mode may occur automatically once the wireless terminal 34 no longer detects the presence of the control signal or responsive to a user command to restore the previous operational mode.

In additional exemplary embodiments, the detection device 20 may be used to broadcast a message to wireless terminals 34 within the restricted area 34. For example, the control signal may include a command that instructs the wireless terminals 34 to present a message on a display of the wireless terminal 34. The message may include advertisements or announcements pertaining to people in the restricted area 34. In exemplary embodiments, a movie theater may use the message to advertise specials at the concession stand. In alternative exemplary embodiments, the message may include an announcement of the features of the preferred operating mode or any other announcement pertaining to people in the restricted area.

As described above, embodiments may be in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A device for providing a preferred operational mode to a wireless terminal comprising:
a transmitter for transmitting signals inside an area; and
a processor operable for instructing the transmitter to transmit a control signal notifying the wireless terminal of a preferred operational mode of the wireless terminal for the area.

2. The device of claim 1, further comprising a receiver for receiving an overhead signal from the wireless terminal.

3. The device of claim 2, wherein the receiver is a detector operable for detecting the proximity of the wireless terminal.

4. The device of claim 1, wherein the preferred operational mode of the wireless terminal includes at least one of a setting of the wireless terminal and an availability of a feature of the wireless terminal.

5. The device of claim 1, wherein the processor is operable for instructing the transmitter to broadcast messages to be displayed on wireless terminals.

6. The device of claim 4, wherein the setting of the wireless terminal comprises at least one of the following:
a ring volume;
a ring tone;
an alert volume;
an alert tone;
a flash; and
a backlight intensity.

7. The device of claim 4 wherein the feature of the wireless terminal comprises at least one of the following:
a voice call;
a SMS;
an email;
a camera functionality;
a video functionality; and
a pager.

8. The device of claim 1, wherein the area is a restricted area in which the unrestricted use of the wireless terminal is not permitted.

9. A method for proximity detection of a wireless terminal comprising:
determining a preferred operational mode of the wireless terminal inside an area; and
transmitting a control signal indicating the preferred operational mode for the area to the wireless terminal.

10. The method of claim 9 comprising restoring a previous operational mode of the wireless terminal when the wireless terminal leaves the area.

11. The method of claim 9 wherein the operational mode of the wireless device includes at least one of a setting of the wireless terminal and an availability of a feature of the wireless terminal.

12. The method of claim 11 wherein the setting of the wireless terminal comprises at least one of the following:
a ring volume;
a ring tone;
an alert volume;
an alert tone;
a flash; and
a backlight intensity.

13. The method of claim 11 wherein the feature of the wireless terminal comprises at least one of the following:
a voice call;
a SMS;
an email;
a camera functionality;
a video functionality; and
a pager.

14. The method of claim 9, wherein the area is a restricted area in which the unrestricted use of the wireless terminal is not permitted.

15. A computer program product for proximity detection of a wireless terminal, the computer program product comprising:
a storage medium readable by a processing circuit and storing instructions for execution by the processing circuit for facilitating a method comprising:
determining a preferred operational mode of the wireless terminal inside an area; and
transmitting a control signal indicating the preferred operational mode for the area to the wireless terminal.

16. The computer program product of claim 15 wherein the operational mode of the wireless device includes at least one of a setting of the wireless terminal and an availability of a feature of the wireless terminal.

17. The computer program product of claim 16 wherein the setting of the wireless terminal comprises at least one of the following:
a ring volume;
a ring tone;
an alert volume;
an alert tone;
a flash; and
a backlight intensity.

18. The computer program product of claim 16 wherein the feature of the wireless terminal comprises at least one of the following:
a voice call;
a SMS;
an email;
a camera functionality;
a video functionality; and
a pager.

19. The computer program product of claim 15, wherein the area is a restricted area in which the unrestricted use of the wireless terminal is not permitted.

20. The computer program product of claim 15 further comprising storing a preferred operational mode of the wireless terminal in the area.
